(19) United States
(12) Patent Application Publication
(10) Pub. No.: US 2026/0212557 A1
(43) Pub. Date: Jul. 23, 2026

(54) HERO SECTION IDENTIFICATION FOR DIGITAL CONTENT GENERATION

(71) Applicant: Adobe Inc., San Jose, CA (US)

(72) Inventors: Prerna Bothra, Bikaner (IN); Rahul Gupta, Noida (IN)

(73) Assignee: Adobe Inc., San Jose, CA (US)

(21) Appl. No.: 19/033,875

(22) Filed: Jan. 22, 2025

(51) Int. Cl. G06T 11/60; G06F 40/14; G06F 40/186; G06V 10/764

(52) U.S. Cl. CPC G06T 11/60; G06F 40/14; G06F 40/186; G06V 10/764

(57) ABSTRACT

In identifying the hero section for digital content generation, a processing device receives a user prompt to generate digital content. The user prompt generally indicates one or more objectives for the digital content. A machine-learning model identifies a hero section in a template for generating the digital content. The hero section is identified based on multiple features associated with one or more images or textual elements in the template. Images features considered for hero images include the number of elements above the candidate image, the size of the elements above the candidate image, image dimensions, vertical positioning, or aspect ratio. Text features considered for candidate textual elements include the display level, ordering, size, container level, relative size, or a size of textual elements above the candidate textual element. The machine-learning model then generates the digital content based on the user prompt with the hero section directed to the objectives.

### BACKGROUND

Generative machine-learning and artificial intelligence (AI) models are trained to generate digital content (e.g., emails, brochures, documents, invitations) based on natural language text inputs. Once trained, a machine-learning model receives text-based inputs such as “draft a marketing email for Acme Hotel.” In response to receiving the prompt, the machine-learning model generates an email promoting the hotel.

Conventional machine-learning models generate responses with digital content arranged in a generally pleasing layout. However, these conventional models do not identify a hero section that includes elements meant to capture a reader's attention and convey the main message. As a result, the hero section is often treated as other sections, leading to misalignment between the user's objective and the content's impact.

### SUMMARY

Techniques and systems for identifying a hero section for digital content generation are described. In one example, a machine-learning model of a processing device receives a user input or prompt to generate digital content. The prompt includes one or more objectives for the digital content. The machine-learning model, for example, is a generative model trained to produce various content, including emails, brochures, flyers, promotional materials, documents, etc. The machine-learning model can receive or retrieve a template for the digital content based on the type of digital content to be generated. For example, a Hypertext Markup Language (HTML) email template with images and textual content is used for generating a marketing email for a particular hotel.

The processing device identifies the hero section of the template. The hero section includes visual and textual elements of digital content to portray the main message and capture a viewer's attention. For example, the processing device indicates the hero image and the hero content of the template to the machine-learning model. The machine-learning model then generates the digital content based on the user prompt, with the hero section populated with content directed to the objectives. In this way, the described techniques for digital content generation provide material that properly aligns with the user's intent and ensures that the prominent portion of the digital content addresses the user's objectives.

This Summary introduces a selection of concepts in a simplified form that are further described below in the Detailed Description. As such, this Summary is not intended to identify essential features of the claimed subject matter, nor is it intended to be used to determine the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 illustrates a digital medium environment in an example implementation that is operable to employ techniques and systems for hero section identification for digital content generation as described herein.

FIG. 2 depicts a system of an example implementation to identify a hero section for digital content generation as described herein.

FIG. 3 depicts a procedure in an example implementation of identifying a hero image in the generation of digital content.

FIG. 4 depicts a procedure in an example implementation of identifying hero content in the generation of digital content.

FIG. 5A depicts an example template in which the described techniques are used to identify the hero image.

FIG. 5B depicts an example template in which the described techniques are used to identify the hero image.

FIGS. 5C and 5D illustrate examples of content generated using conventional techniques versus the described techniques that utilize hero section analysis.

FIG. 6 illustrates a procedure in an example implementation of hero section identification for digital content generation.

FIG. 7 illustrates an example system including various components of an example device that can be implemented as any computing device as described and/or utilized with reference to FIGS. 1-6 to implement embodiments of the techniques described herein.

### DETAILED DESCRIPTION

### Overview

Generative machine-learning models generate digital content (e.g., marketing emails and brochures with digital images and text) based on natural language text inputs. Conventional techniques use machine-learning models to generate responses with different types of digital content arranged in a generally pleasing or cohesive layout. However, these conventional techniques do not provide a mechanism to identify or select a hero section, which includes visual and/or textual elements meant to capture a reader's attention and convey the main message, within the content. As a result, the key section is often treated as other sections or content in a template, leading to misalignment between the user's objective and the impact of the generated content.

In contrast, the described systems and techniques accurately identify and prioritize hero sections in generating digital content. Using a probabilistic approach with weighting techniques, the described system analyzes key features of potential hero images and hero content in HTML-based or other templates. The system then combines these probabilities to detect the hero section reliably.

For example, if an email opens with an image or section that fails to align with the overall intent—such as featuring a gym image and focusing on gym details instead of showcasing a resort's scenic view for an email marketing a resort to perspective clients—the layout can significantly undermine the email's impact. This misalignment leads to a disconnect with the audience, diminishing the overall effectiveness of the message.

The described techniques for hero section identification allow for highly personalized content generation by dynamically selecting elements that resonate with user objectives. For example, an e-commerce retailer can tailor an email to feature a hero section highlighting personalized content based on a customer's browsing history. If a user frequently explores outdoor adventures, the generative model can present a hero section showcasing a scenic view with a message about camping gear.

In an example implementation, a hero section module identifies and prioritizes a hero section within the content to be generated. While many conventional techniques treat the hero section as any other section in the generated content or assume the first or largest section is the hero section, the described hero section module uses a probabilistic approach to analyze key features associated with potential hero images and hero content and integrates these insights with weighting techniques. By leveraging a set of predefined features and a weighted combination algorithm, the hero section module accurately determines which section should be highlighted as the hero section.

To identify the hero section, the hero section module considers different characteristics or features of an image or text content associated with hero sections. These features are selected based on their influence in determining the prominence and importance of an image within digital content. In one implementation, the image features considered for a hero image include the number of elements above the image, the size of elements above the image, dimensions, positioning, aspect ratio, and sibling images. In the same or another implementation, the text features considered for hero content include the display level, element level, element size, size of higher elements, container level, and relative size.

The hero section module then calculates a probability corresponding to each feature for each candidate element. The probabilities are generally determined using historical data and binning the feature values, where each feature is divided into value ranges with an associated probability value. For example, if seventy percent of images in the “top” bin of the positioning feature are hero images, the probability for the “top” bin is 0.7.

The hero section module also defines weights for each feature. In one implementation, weights are dynamically assigned to each feature that reflects the relative importance of each feature in identifying hero sections. The probabilities and corresponding weights are combined to generate a final probability that each candidate element is a hero section. The hero section module uses a probabilistic fusion approach with log-likelihood ratios and weighted probabilities to combine the probabilities and weights to produce a final probability. This probabilistic fusion approach ensures that each feature's relative importance and corresponding likelihood are accounted for in the final probability.

The hero section module then normalizes the weights assigned to each feature so the sum of the weights equals one. The weight normalization avoids any one feature disproportionately influencing the final probability. In one implementation, the hero section module also determines each feature's weighted LLR to balance the probability of a candidate element being a hero section against the probability of the candidate element not being a hero section. The weighted LLR approach provides greater precision to the final probability for each candidate image. If the final probability exceeds a predefined threshold (e.g., 0.7), the hero section module classifies the candidate element as part of a hero section. The candidate element is not classified as part of the hero section if the final probability is not higher than the predefined threshold.

Accordingly, the hero section module correctly identifies the prominent image and content within a formatting template, improving content quality and aligning with user objectives. The described techniques facilitate more impactful and effective communication by accurately highlighting the desired message in generated content.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “diffusion model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt. Diffusion models can also be distilled to decrease the number of parameters or the number of inference steps, which can in some cases enable these models to run locally on user devices.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

A “hero section” is a document or other digital media portion that includes the most prominent visual and/or textual elements, encapsulating the document's central message and capturing a viewer's attention. The hero section generally includes a “hero image” (e.g., a photograph, image, video, or other visual element) and/or “hero content” (e.g., textual elements). A hero image is a prominent digital image that serves as the key visual element in digital content. Hero content provides the main or key message of a document.

The following discussion describes an example environment that employs the techniques described herein. Example procedures that are performable in the example environment and other environments are also described. Consequently, the performance of the example procedures is not limited to the example environment, and the example environment is not limited to the performance of the example procedures.

### Example Environment for Generating Digital Content

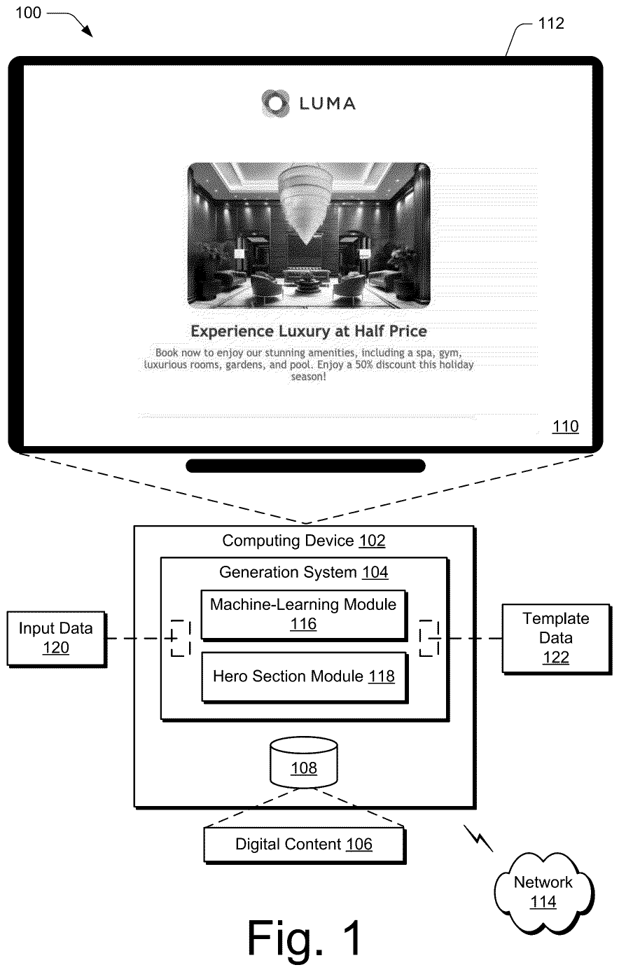

FIG. 1 is an illustration of a digital medium environment 100 in an example implementation that is operable to employ techniques and systems for hero section identification for digital content generation as described herein. The digital medium environment 100 includes a computing device 102, which is configurable in various ways.

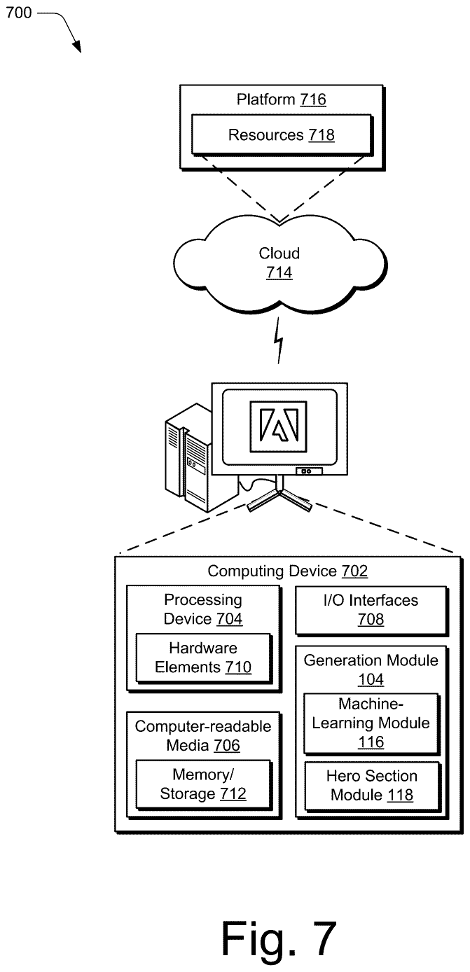

The computing device 102, for instance, is configurable as a desktop computer, a laptop computer, a mobile device (e.g., assuming a handheld configuration such as a tablet or mobile phone), an augmented reality device, and so forth. Thus, computing device 102 ranges from full-resource devices with substantial memory and processor resources (e.g., personal computers and game consoles) to a low-resource device with limited memory and/or processing resources (e.g., mobile devices). Additionally, although a single computing device 102 is shown, the computing device 102 is also representative of a plurality of different devices, such as multiple servers a business utilizes to perform operations “over the cloud” as described in FIG. 7.

The computing device 102 also includes a generation system 104 to generate various types of digital content, including emails, brochures, and webpages. The generation system 104 is implemented at least partially in the hardware of the computing device 102 to process and represent digital content 106, illustrated as maintained in storage 108 of the computing device 102. The digital content 106 includes digital images, digital artwork, digital videos, and/or digital compilations of text and data. Such processing includes creating the digital content 106, representing the digital content 106, modifying the digital content 106, and rendering the digital content 106 for display in a user interface 110 for output, e.g., by a display device 112.

The display device 112 is communicatively coupled to the computing device 102 via a wired or wireless connection. A variety of device configurations are usable to implement the computing device 102 and/or the display device 112. Although illustrated as implemented locally at the computing device 102, functionality of the generation system 104 is also configurable entirely or partially via functionality available via the network 114, such as part of a web service or “in the cloud.”

The computing device 102 also includes a machine-learning model 116 and a hero section module 118, illustrated as incorporated by the generation system 104 to process the digital content 106 and input data 120. In some examples, the machine-learning model 116 and the hero section module 118 are separate from the generation system 104, such as in an example in which data alignment, transfer learning, and/or refinement features of the machine-learning model 116 and the hero section module 118, respectively, are available via the network 114.

The generation system 104 is illustrated as having, receiving, and/or transmitting input data 120 describing a characteristic or prompt for digital content. For instance, the digital content is to be generated by the generation system 104 and the characteristic indicates an objective for the digital content and/or how to generate the digital content. In one example, the input data 120 includes a natural language statement to create a marketing email for a hotel. In this example, the objective of the digital content (e.g., a marketing email) is to showcase the features and amenities of the hotel.

The generation system 104 receives and processes the input data 120 to generate the digital content in response to the user prompt. In at least one implementation, the generation system 104 includes or has access to a machine-learning model 116 trained on training data to generate digital content from natural language prompts in the input data 120, and the generation system 104 implements the machine-learning model 116 to generate the digital content.

In one implementation, the generation system 104 is illustrated as having, receiving, and/or transmitting template data 122, which describes information related to formatting templates for digital content 106 such as different templates for different types of content (e.g., emails versus brochures versus webpages) and/or objectives (e.g., promotional versus informational).

In some examples, the machine-learning model 116 is a large language model capable of performing various natural language tasks after being trained on corpuses of training data. In an example, the input text includes a request for the machine-learning model 116 to generate output text and/or images based on the input text such that the output text is formatted in JavaScript Object Notation. The machine-learning model 116 is included in or available to the generation system 104, and the generation system 104 implements the machine-learning model to process the prompt in the input data 120.

The hero section module 118 identifies and prioritizes a hero section within the content to be generated. The hero section generally includes the hero image (if any) and the hero content (e.g., textual elements). The hero section module 118 uses a probabilistic approach to analyze key features associated with potential hero images and hero content and integrates these insights with weighting techniques. By leveraging a set of predefined features and a weighted combination algorithm, the hero section module 118 accurately determines which section should be highlighted as the hero section.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Hero Section Identification

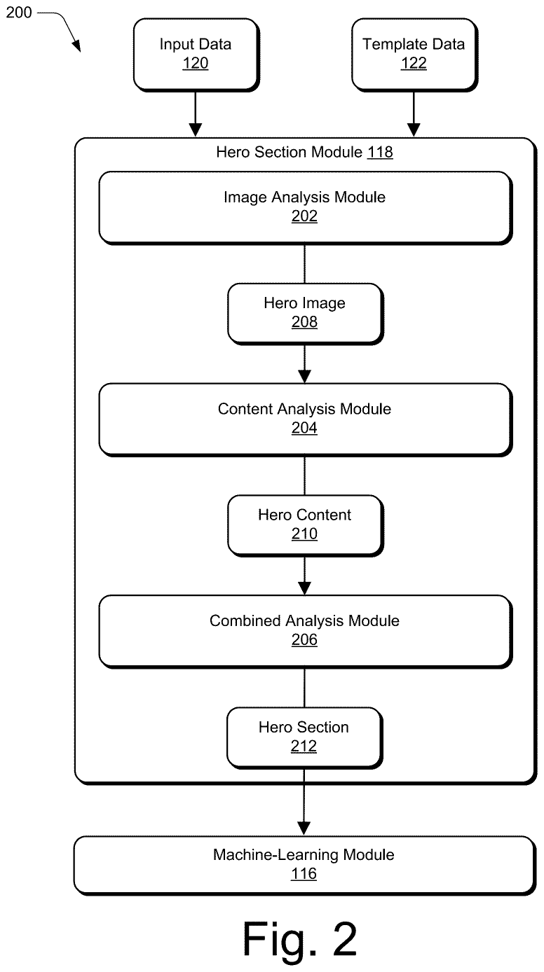

FIG. 2 depicts a system 200 of an example implementation to identify a hero section for digital content generation as described herein. The following discussion describes techniques implementable utilizing the previously described systems and devices. Aspects of each procedure or operation are implemented in hardware, firmware, software, or a combination thereof.

Inputs to the system 200 include input data 120 and template data 122. The system 200 includes the machine-learning model 116 and hero section module 118, which includes an image analysis module 202, a content analysis module 204, and a combined analysis module 206.

The image analysis module 202 uses a probabilistic approach to analyze key features associated with images in the template data 122 to identify a hero image 208. In particular, the image analysis module 202 applies a weighted log-likelihood ratio (LLR) approach to the key features to determine a final probability for each image being the hero image. Similarly, content analysis module 204 uses a probabilistic approach to analyze key features associated with textual elements in the template data 122 to identify hero content 210. The probabilistic approach used by the content analysis module 204 is adapted based on whether a hero image 208 is identified.

The image analysis module 202 and the content analysis module 204 determine a weighted LLR for each feature to account for varying significance across the considered features. The weighted LLR balances the probability of an element (e.g., an image or textual content) being a hero element and the probability of the element not being a hero element. In this way, the hero section module 118 considers the presence and absence of hero section characteristics and effectively addresses edge cases.

The combined analysis module 206 uses a combining technique to consider the identified hero image 208 and/or hero content 210 and identify the hero section 212. The combined analysis module 206 uses a dynamic multi-modal feature fusion (DMMFF) technique to integrate different data modalities (e.g., visual, textual, and structural features) into a single representation. The DMMFF technique allows the combined analysis module 206 to process and combine data from various sources, such as image attributes, text properties, and their relative positioning in the template (e.g., within HTML content). The combined analysis module 206 also uses a probabilistic fusion approach to merge individual feature probabilities (e.g., image size, text hierarchy, or positioning) into an overall probability score for hero section identification. This multi-objective optimization approach balances different business or content goals like brand identity, engagement, and visual impact to provide a balanced integration of different probabilities. For example, larger images tend to suggest a hero image, but textual prominence may override that determination.

The image analysis module 202 and the content analysis module 204 also employ reinforcement learning to dynamically adjust the weights assigned to various features. In one implementation, the weights are set with predefined values and run on a dataset of templates. A large language model (LLM) or other machine-learning model acts as a judge to evaluate the accuracy of the hero section identification and the weights are iteratively updated based on the LLM feedback to optimize each module's performance. The iterative learning ensures that the weights reflect real-world conditions and feedback, enabling the image analysis module 202 and the content analysis module 204 to improve over time.

The machine-learning model 116 receives the input data 120 and the hero section 212. For example, the machine-learning model 116 can include a generative machine-learning model. Examples of generative machine-learning models include a model trained on training data to generate digital images, a diffusion model, a Generative Pre-Trained Transformer 4 model (GPT-4), a Hierarchical Text-Conditional Image Generation with CLIP Latents model (DALL·E 2), etc. In some examples, the machine-learning model 116 includes systems of generative machine-learning models.

In an example, the machine-learning model 116 generates digital content components by processing the input data 120 (e.g., a user prompt). The machine-learning model uses the template data 122 as a formatting guide for the generated content, with content associated with the main objective(s) located or highlighted in the hero section 212.

### Example Procedures for Hero Section Identification

The following discussion describes implementable techniques utilizing the previously described systems and devices. Aspects of each procedure are implementable in hardware, firmware, software, or a combination thereof. The procedures are shown as blocks that specify operations performed by one or more devices and are not necessarily limited to the orders shown for performing the operations by the respective blocks. In portions of the following discussion, reference is made to FIGS. 1 and 2.

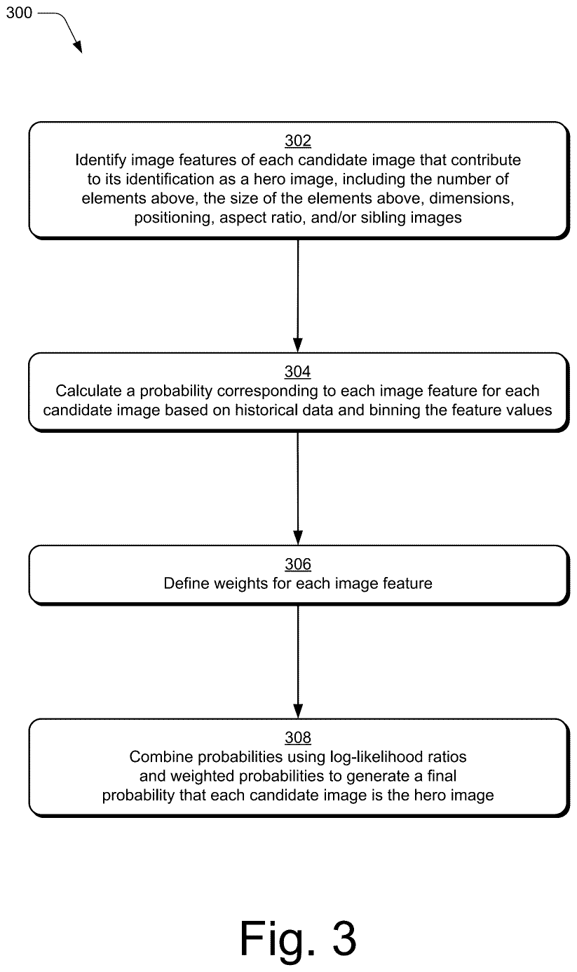

FIG. 3 depicts a procedure 300 in an example implementation of identifying a hero image 208 of a digital template. A hero image is a prominent digital image that serves as the key visual element in digital content.

To begin, image features of each image are identified that contribute to its identification as the hero image (block 302). The image analysis module 202 identifies different image characteristics or features of an image (e.g., in HTML content) commonly associated with hero images. The image features are selected based on their potential influence in determining the prominence and importance of an image within digital content. In one implementation, the image features include the number of elements above the image, the size of elements above the image, dimensions, positioning, aspect ratio, and sibling images.

The number of elements above the image identifies the elements (e.g., text, images, etc.) positioned above the image. Fewer elements above an image suggest the image is more prominent, making the particular image more likely to be a hero image. The size of elements above the image considers the cumulative size of elements above the image. Larger element sizes push the image further down, reducing the particular image's prominence and likelihood of being a hero image.

The dimensions feature considers the width and height of an image. Larger images are more eye-catching and thus more likely to be hero images. The positioning feature considers the vertical positioning of the image relative to the top of the page. Images closer to the top are often considered more important and more likely to be hero images. An image's aspect ratio evaluates the ratio between the width and height to identify potential hero images. Images with very large or small aspect ratios (e.g., extreme horizontal or vertical ratios) are typically not hero images because they do not engage users effectively. The aspect ratio feature ensures selected images have appropriate visual proportions to enhance content quality and alignment.

The sibling images feature determines whether an image has one or more sibling images within the same container (e.g., logical sections of HTML content, including header, main, and footer sections). A single image with no siblings is often the focal point of the content, making the image a strong candidate for the hero image. The sibling analysis considers the image size differences (e.g., by comparing the height and/or width of the current image and adjacent images), elements between the images (e.g., by identifying the number of elements between the current image and adjacent images), and display-level differences (e.g., by assessing the vertical positioning of the current image and adjacent images). Images with similar sizes and vertical positioning are likelier to be sibling images.

The image analysis module 202 then calculates a probability corresponding to each image feature for each candidate image (e.g., potential hero image) (block 304). The probabilities corresponding to different image features are determined using historical data and binning the feature values. Each image feature (e.g., from block 302) is divided into value ranges or bins representing different values the image feature can have. For example, the positioning feature is divided into three bins (e.g., top, middle, and bottom) based on the relative positioning of the image on the page. For each bin, the probability of a candidate image being a hero image is determined based on the proportion of hero images (e.g., the number of hero images in the bin divided by the total number of images in the bin). For example, if seventy percent of images in the “top” bin are hero images, the probability for the “top” bin is 0.7.

The image analysis module 202 also defines weights for each image feature (block 306). For example, the image analysis module 202 uses a dynamic weighting technique to assign weights to each image feature that reflects the relative importance of each image feature in identifying hero images. In one implementation, the weights are initially set based on domain expertise or insights into the relative influence of the different image features. In one implementation, image positioning is assigned a higher weight than the number of higher elements because an image's position within a template or HTML content is generally a more significant indicator of prominence.

Weights are dynamically adjusted over time to improve prediction accuracies. In one implementation, the image analysis module 202 monitors the performance of hero image identification and iteratively fine-tunes the weights to improve its effectiveness.

The image analysis module 202 combines the probabilities and corresponding weights to generate a final probability that each candidate image is the hero image (block 308). The image analysis module 202 uses a probabilistic fusion approach with log-likelihood ratios and weighted probabilities to combine the probabilities and weights to produce the final probability. This probabilistic fusion approach ensures that each image feature's relative importance and corresponding likelihood are accounted for in the final probability.

The image analysis module 202 determines if the probability of any image feature is decisively high or low. If a probability exceeds a predetermined high threshold or falls below a predetermined low threshold, the image analysis module 202 immediately determines the hero image classification without considering other image features. Different high thresholds and low thresholds can be established for different image features. Some image features do not include high and/or low thresholds in one implementation.

The image analysis module 202 then normalizes the weights assigned to each image feature so the sum of the weights equals one. The weight normalization avoids any one image feature disproportionately influencing the final probability. The image analysis module 202 then determines each image feature's weighted LLR to balance the probability of a candidate image being a hero image against the probability of the candidate image not being a hero image. The weighted LLR approach provides greater precision to the final probability for each candidate image, which is calculated using the following equation:

$${LLR}_{weighted} = \sum ( {w}_{i} ( log ( {P}_{i} ) - log ( 1 - {P}_{i} ) ) ) ,$$

where wᵢ and Pᵢ represent the weight and probability associated with the ith image feature.

The weighted LLR is converted to the final probability, with a value between zero and one, using the logistic function:

$${P}_{final} = \frac{1}{1 + {e}^{{LLR}_{weighted}}} .$$

If the final probability is higher than a predefined threshold (e.g., 0.7), the image analysis module 202 classifies the candidate image as a hero image. If the final probability is not higher than the predefined threshold, the candidate image is not classified as a hero image.

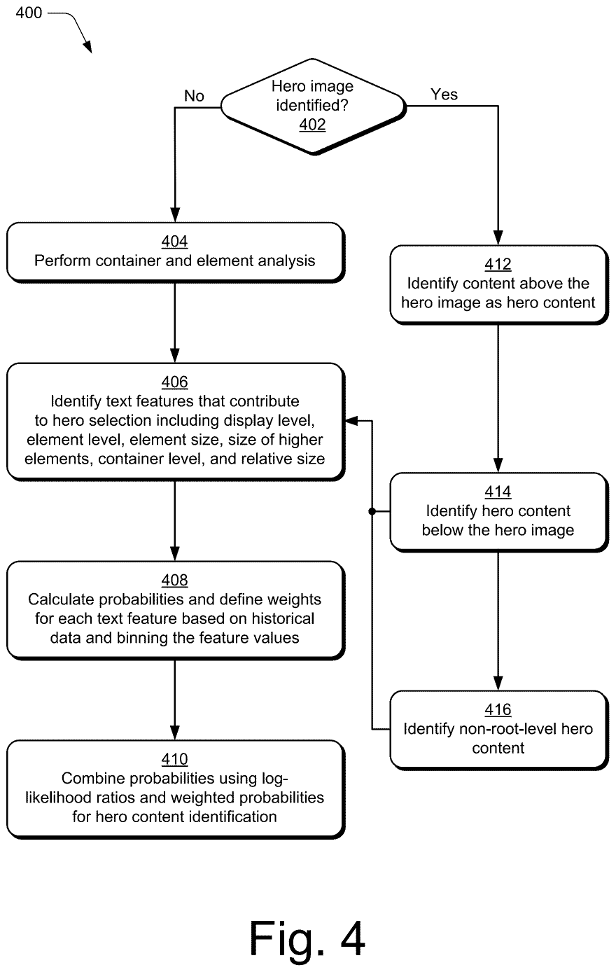

FIG. 4 depicts a procedure 400 in an example implementation of identifying hero content (e.g., text) for digital content generation. Hero content is a prominent textual element (e.g., heading, caption, sentence, paragraph) in a template that is the primary message or headline in digital content (e.g., to capture the viewer's attention).

To begin, it is determined whether a hero image was identified (e.g., as part of procedure 300 in FIG. 3) (block 402). For example, the content analysis module 204 determines whether a hero image 208 was identified by the image analysis module 202. Procedure 400 differs or diverges based on this determination.

In response to determining that a hero image was not identified (e.g., a “no” or “N” response at block 402), container and element analysis is performed (block 404). For example, content analysis module 204 analyzes the containers or sections within the template to identify the hero content. In particular, each container is analyzed to retrieve each element or textual content within the container. Each element in a particular container is analyzed to determine whether the element qualifies as hero content. If an element within the container is identified as not being hero content, the content analysis module 204 discards that container and does not process the other elements within the container.

Text features that contribute to selection as hero content are identified (block 406). For example, a processing device or machine-learning model of the content analysis module 204 is trained to identify specific text characteristics or features of container elements in templates or HTML-based content commonly associated with hero content. These text features are selected based on their potential influence on determining the prominence and importance of a textual element within a template. In one implementation, the text features include the display level, element level, element size, size of higher elements, container level, and relative size.

The display level feature measures an element's vertical position relative to the template's height (e.g., the length of an email template). Elements placed higher on a page are more likely to be hero content because such elements tend to be more prominent and visible to capture the viewer's attention early. Similarly, the element level feature refers to the order of an element within its container. Elements that appear earlier in the sequence have a higher chance of being hero content because important or key information is generally presented upfront for maximum exposure and impact.

The element size feature considers an element's physical size or character count. Larger elements are less likely to be hero content because oversized text can disrupt visual hierarchy and overwhelm the design of the digital content, reducing content engagement. The size of higher elements evaluates the cumulative size of content elements located above the current element. Larger elements above the current element reduce the likelihood of the current element being hero content, as the previous content may have already captured the viewer's attention and engagement.

The container level feature analyzes the hierarchical position of the container holding the element. Elements in higher-level or root containers are more likely to be hero content because such containers generally house more important information. Lastly, the relative size feature compares the size of the current element to the total content size processed so far by the content analysis module 204. If adding the current element results in a disproportionately large cumulative size, the probability of this content being hero content decreases to maintain visual balance and design integrity.

The content analysis module 204 then calculates a probability and defines weights corresponding to each text feature (block 408). The probabilities corresponding to different text features are determined using historical data and binning the text feature values. Each text feature (e.g., from block 406) is divided into value ranges or bins representing different values the text feature can have. For example, the display level feature is divided into three bins (e.g., top, middle, and bottom) based on the relative positioning of the element on the page. For each bin, the probability of an element being hero content is determined based on the proportion of hero content (e.g., the number of hero content in the bin divided by the total number of elements in the bin). For example, if seventy percent of elements in the “top” bin are hero content, the probability for the “top” bin is 0.7.

The content analysis module 204 also defines weights for each text feature. For example, the content analysis module 204 uses a dynamic weighting technique to assign weights to each text feature that reflects the relative importance of each text feature in identifying hero content. In one implementation, the weights are initially set based on domain expertise or insights into the relative influence of the different text features. For example, display level is assigned a higher weight than element size because an element's relative position within a template or HTML content is generally a more significant indicator of prominence than its size.

Weights are dynamically adjusted over time to improve prediction accuracies. In one implementation, the content analysis module 204 monitors the performance of hero content identification and iteratively fine-tunes the weights to improve its effectiveness.

The content analysis module 204 combines the probabilities and corresponding weights to generate a final probability that each element is hero content (block 410). The content analysis module 204 uses the probabilistic fusion approach with LLRs and weighted probabilities to combine the probabilities and weights to produce the final probability. This probabilistic fusion approach ensures that each text feature's relative importance and corresponding likelihood are accounted for in the final probability.

The content analysis module 204 determines if the probability of any element is decisively high or low. If a probability exceeds a predetermined high threshold or falls below a predetermined low threshold, the content analysis module 204 immediately determines the hero content classification without considering other text features. For example, if the display level feature probability is 0.95 or higher, the content analysis module 204 immediately classifies the element as hero content. Different high thresholds and low thresholds can be established for different text features. Some text features do not include high and/or low thresholds in one implementation.

The content analysis module 204 then normalizes the weights assigned to each text feature so the sum of the weights equals one. The weight normalization avoids any one text feature disproportionately influencing the final probability. The content analysis module 204 determines each text feature's weighted LLR to balance the probability of an element being hero content against the probability of the element not being hero content. The weighted LLR approach provides greater precision to the final probability for each element, which is calculated using the following equation:

$$L L {R}_{weighted} = \sum ( {w}_{i} ( log ( {P}_{i} ) - log ( 1 - {P}_{i} ) ) ) ,$$

where wᵢ and Pᵢ represent the weight and probability associated with the ith text feature.

The weighted LLR is converted to the final probability, with a value between zero and one, using the logistic function:

$${P}_{final} = \frac{1}{1 + {e}^{{LLR}_{weighted}}} .$$

If the final probability is higher than a predefined threshold (e.g., 0.7), the content analysis module 204 classifies the element as hero content. The element is not classified as hero content if the final probability is not higher than the predefined threshold.

In response to determining that a hero image was identified (e.g., a “yes” or “Y” response at block 402), hero content above the hero image is identified (block 412). For example, the content analysis module 204 considers each textual element above the hero image 208 as hero content 210 because these elements are part of the introductory section.

The content analysis module 204 then identifies hero content below the hero image (block 414). For example, if the hero image is located at the root level (e.g., directly in a main container), the content analysis module 204 analyzes each element following the hero image 208. For root-level elements, the content analysis module 204 determines if the next element is a container or a regular element. If the next element is a container, each element within the container is analyzed by the content analysis module 204 for inclusion as hero content (e.g., using blocks 406 through 410). If the next element is a regular element, the element is directly analyzed as potential hero content (e.g., using blocks 406 through 410). If the number and size of elements exceed a predefined threshold, the container or individual elements are discarded or limited to elements that meet size and display thresholds. Elements are selectable as hero content until another image is encountered within the digital content. Once a new image is found, further elements are excluded from hero content consideration.

Lastly, the content analysis module 204 identifies non-root-level hero content (block 416). For example, if the hero image 208 is not at the root level, the content analysis module 204 analyzes each element in the same container as the hero image 208. The elements are processed using the same feature set described for block 406 and final probabilities for hero content identification are determined using the procedures described for blocks 408 and 410.

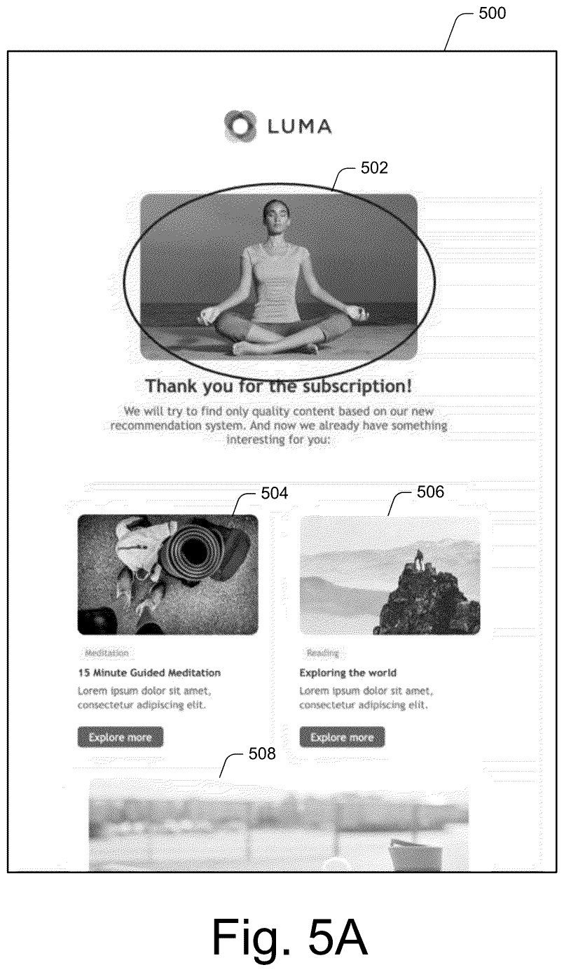

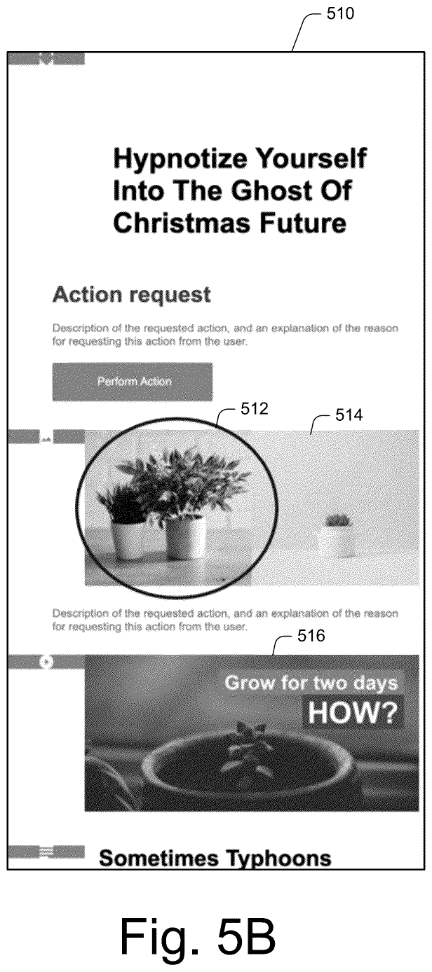

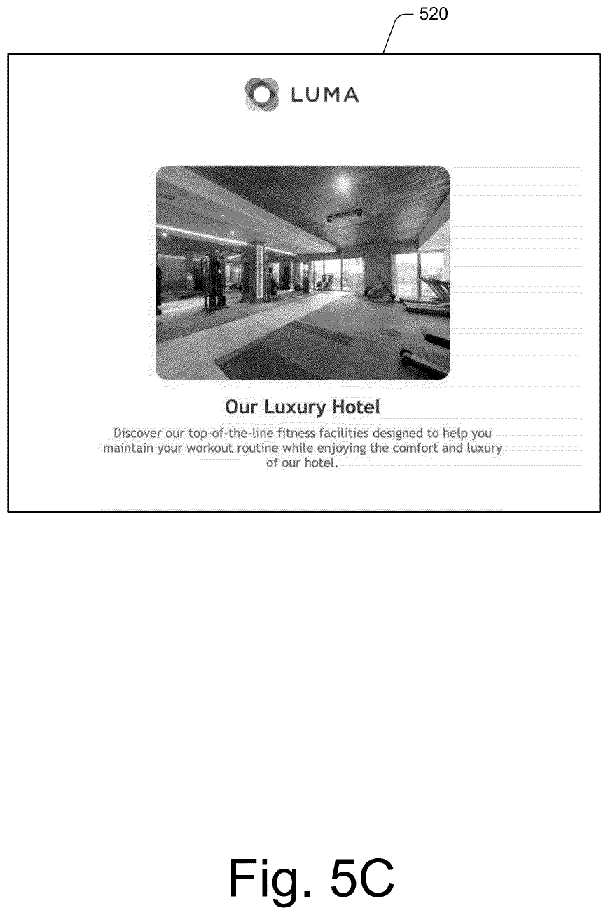

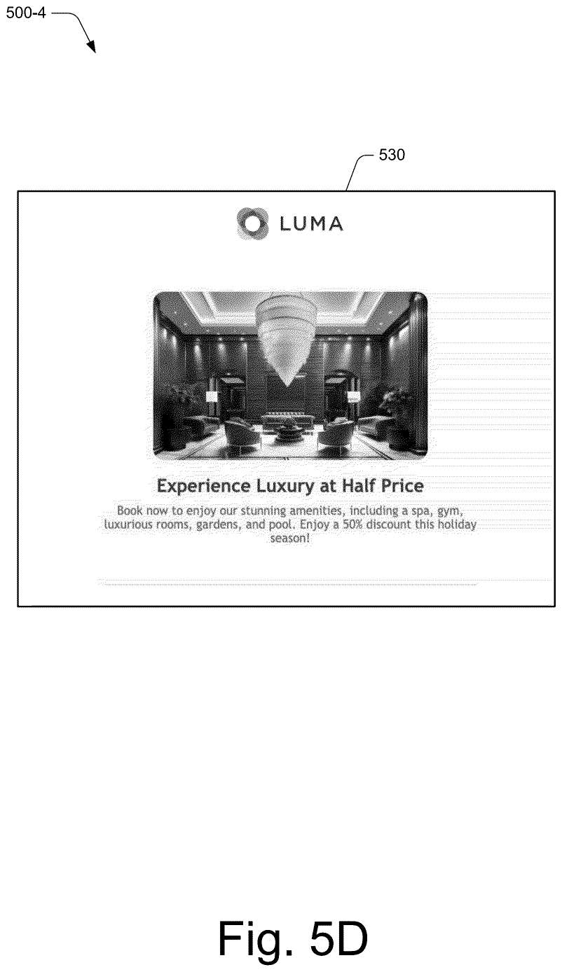

FIG. 5A depicts an example template 500 in which the described techniques are used to identify the hero image. Template 500 includes multiple images, including images 502, 504, 506, and 508. Consider a scenario in which the image analysis module 202 evaluates the first image (e.g., image 502) in the template 500 (e.g., an HTML email template) for hero image status.

Using procedure 300 described in reference to FIG. 3, the image analysis module 202 determines the following probabilities associated with each feature, which reflect the likelihood of image 502 being the hero image: 0.9 for the number of higher elements, 0.95 for the size of higher elements, 0.6 for the dimensions feature, 0.8 for the positioning feature, 0.9 for the image's aspect ratio, and 0.93 for the sibling images feature. The image analysis module 202 assigns the following weights for the respective features: 0.1, 0.15, 0.2, 0.2, 0.1, and 0.25. As noted above, the weights sum to one.

Using the noted probabilities and weights, the image analysis module 202 calculates the weighted LLR as 1.8857 (e.g., LLR_{weighted}=(0.1*2.197)+(0.15*2.944)+(0.2*0.405)+(0.2*1.386)+(0.1*2.197)+(0.25*2.586)). The weighted LLR is then converted to a final probability of 0.87 using the logistic function. This final probability value of 0.87 indicates that image 502 is a hero image.

FIG. 5B depicts an example template 510 in which the described techniques are used to identify the hero image. Template 510 includes multiple images, including images 512, 514, and 516. Consider a scenario in which the image analysis module 202 evaluates the first image (e.g., image 512) in template 510 (e.g., an HTML email template) for hero image status.

Using procedure 300 described in reference to FIG. 3, the image analysis module 202 determines the following probabilities associated with each feature, which reflect the likelihood of image 512 being the hero image: 0.5 for the number of higher elements, 0.6 for the size of higher elements, 0.65 for the dimensions feature, 0.8 for the positioning feature, 0.8 for the image's aspect ratio, and 0.001 for the sibling images feature. The image analysis module 202 assigns the following weights for the respective features: 0.1, 0.15, 0.2, 0.2, 0.1, and 0.25. As noted above, the weights sum to one.

Using the noted probabilities and weights, the image analysis module 202 calculates the weighted LLR as −1.2615 (e.g., LLR_{weighted}=(0.1*0)+(0.15*0.405)+(0.2*0.619)+(0.2*1.386)+(0.1*1.386)−(0.25*6.906)). The logistic function converts the weighted LLR to a final probability of 0.22. This final probability value of 0.22 is well below the threshold for classifying an image as a hero image, indicating that image 512 is not a hero image. Although several features strongly indicate that image 512 could be a hero image, the significantly low probability of the sibling image feature had a significant negative impact on the final probability. Image 512 illustrates that the described techniques account for extreme outliers to ensure that an image with a large disadvantage for one or more features is not erroneously classified as a hero image.

FIGS. 5C and 5D illustrate example contents 520 and 530 generated using a conventional technique for generating content versus the described techniques that utilize hero section analysis. A generation system receives the following input objective: “Promote the hotel and its amenities, including the spa, gym, luxurious rooms, gardens, and pool, while highlighting a 50% discount available for the upcoming holiday season.” Without the described hero section techniques, a conventional generation system generates content 520 in FIG. 5C. In contrast, the generation system 104 with the hero section module 118 generates content 530 in FIG. 5D.

Content 520 emphasizes a single feature (e.g., the gym), which lacks the broader appeal of the hotel and results in a less engaging email. In contrast, after applying hero section identification, content 530 effectively captures the intent and marketing objective, providing a more comprehensive, visually appealing, and engaging viewer experience.

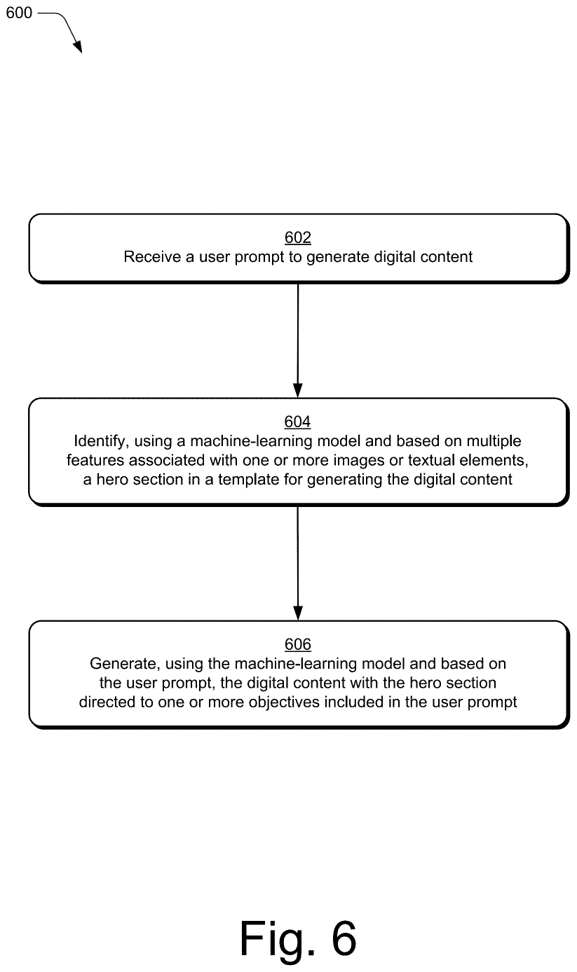

FIG. 6 illustrates a procedure 600 in an example implementation of hero section identification for digital content generation. To being, a processing device receives a user prompt to generate digital content (block 602). The user prompt includes one or more objectives for the digital content.

A machine-learning model identifies a hero section in a template for generating the digital content (block 604). The hero section is identified based on multiple features associated with one or more images or textual elements in the template. The machine-learning model selects the template based on the objectives or a type of the digital content.

In one example, the template includes multiple images. The machine-learning model identifies a hero image based on multiple features, including at least two of a number of elements above a candidate image, a size of the elements above the candidate image, image dimensions of the candidate image, a vertical positioning of the candidate image, an aspect ratio of the candidate image, and whether the candidate image has sibling images. Sibling images are identified by comparing the vertical positioning, the image dimensions, and the aspect ratio of other images to the candidate image.

The machine-learning model identifies the hero image by determining a probability that the image is a hero image for each image of the multiple images and each feature of the multiple features. The probability for each image and each feature is determined based on a probability value associated with a range (or bin) of feature values, which is determined based on historical data. The machine-learning model also assigns a weight for each feature. The weight for each feature is determined based on historical data and normalized to sum to one.

The machine-learning model then determines, for each image and based on a summed weighted log-likelihood ratio for the multiple features, a combined probability that the image is the hero image. The summed weighted log-likelihood ratio is determined by summing a weighted log-likelihood ratio for each feature, which is equal to the weight times a difference of a log of the probability and the log of one minus the probability. The combined probability equals an inverse of one plus an exponential function of negative one times the weighted log-likelihood ratio. The image is classified as a hero image in response to the combined probability exceeding a predetermined threshold.

In another example, the template includes multiple textual elements. Hero content from the multiple textual elements is identified based on at least two of a display level of a candidate textual element, an ordering of the candidate textual element, a size of the candidate textual element, a size of textual elements above the candidate textual element, a level of a container holding the candidate textual element, and a relative size of the candidate textual element. In response to identifying a hero image, the machine-learning model identifies the hero content by classifying each textual element above the hero image as hero content. In response to the hero image being in the main section of the template, the machine-learning model analyzes each textual element below the hero image based on the multiple features until another image is encountered in the template. In response to the hero image not being in the main section, the machine-learning model analyzes each textual element in the same section as the hero image based on the multiple features described above.

If a hero image is not identified or present in the template, the machine-learning model identifies the hero content by retrieving each textual element of each template section, starting with the first section. The machine-learning model then analyzes each textual element to determine whether the textual element is hero content by determining a probability that the textual element is hero content for each feature of the multiple features associated with hero content. A weight is assigned to each feature. Based on a summed weighted log-likelihood ratio for the multiple features, the machine-learning model then determines a combined probability that the textual element is the hero content. The textual element is classified as hero content in response to the combined probability exceeding a predetermined threshold. Each textual element in a template section is classified as not hero content in response to a single textual element in the section being classified as not hero content.

The machine-learning model generates the digital content with the hero section directed to the objectives based on the user prompt (block 606).

### Example System and Device

FIG. 7 illustrates an example system 700 that includes an example computing device 702 that is representative of one or more computing systems and/or devices that implement the various techniques described herein. This is illustrated by including the generation system 104, machine-learning model 116, and hero section module 118 of FIG. 1. The computing device 702 is configurable, for example, as a server of a service provider, a device associated with a client (e.g., a client device), an on-chip system, and/or any other suitable computing device or computing system.

The example computing device 702, as illustrated, includes a processing device 704, one or more computer-readable media 706, and one or more I/O interface 708 that are communicatively coupled to one another. Although not shown, the computing device 702 further includes a system bus or other data and command transfer system that couples the various components from one to another. A system bus includes any one or combination of different bus structures, such as a memory bus or memory controller, a peripheral bus, a universal serial bus, and/or a processor or local bus that utilizes various bus architectures. Various other examples are also contemplated, such as control and data lines.

The processing device 704 is representative of the functionality to perform one or more operations using hardware. Accordingly, the processing device 704 is illustrated as including hardware element 710 that is configurable as processors, functional blocks, and so forth. This includes implementation in hardware as an application-specific integrated circuit or other logic device formed using one or more semiconductors. The hardware elements 710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable media 706 is illustrated as including memory/storage 712. The memory/storage 712 represents memory/storage capacity associated with one or more computer-readable media. The memory/storage 712 includes volatile media (such as random access memory (RAM)) and/or nonvolatile media (such as read-only memory (ROM), Flash memory, optical disks, magnetic disks, and so forth). The memory/storage 712 includes fixed media (e.g., RAM, ROM, a fixed hard drive, and so on) and removable media (e.g., Flash memory, a removable hard drive, an optical disc, and so forth). The computer-readable media 706 is configurable in various ways, as described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in various ways to support user interaction, as further described below.

Various techniques are described in the general context of software, hardware elements, or program modules. Generally, such modules include routines, programs, objects, elements, components, data structures, and so forth that perform particular tasks or implement abstract data types. The terms “module,” “functionality,” and “component” as used herein generally represent software, firmware, hardware, or a combination thereof. The features of the techniques described herein are platform-independent, meaning that the techniques are configurable on various commercial computing platforms with various processors.

An implementation of the described modules and techniques is stored on or transmitted across some form of computer-readable media. The computer-readable media includes a variety of media that is accessed by the computing device 702. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium configured to transmit instructions to the hardware of the computing device 702, such as via a network. Signal media typically embodies computer-readable instructions, data structures, program modules, or other data in a modulated data signal, such as carrier waves, data signals, or another transport mechanism. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representatives of modules, programmable device logic, and/or fixed device logic implemented in a hardware form that is employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employed to implement various techniques described herein. Accordingly, software, hardware, or executable modules are implemented as instructions and/or logic embodied on some form of computer-readable storage media and/or by one or more hardware elements 710. The computing device 702 is configured to implement particular instructions and/or functions corresponding to the software and/or hardware modules. Accordingly, implementation of a module executable by the computing device 702 as software is achieved at least partially in hardware, e.g., through computer-readable storage media and/or hardware elements 710 of the processing device 704. The instructions and/or functions are executable/operable by one or more articles of manufacture (for example, one or more computing devices and/or processing devices 704) to implement techniques, modules, and examples described herein.

The techniques described herein are supported by various configurations of the computing device 702 and are not limited to the specific examples of the techniques described herein. This functionality is also implementable through a distributed system, such as over a “cloud” 714 via a platform 716 as described below.

Cloud 714 includes and/or represents a platform 716 for resources 718. Platform 716 abstracts the underlying functionality of hardware (e.g., servers) and software resources of the cloud 714. Resources 718 include applications and/or data that can be utilized when computer processing is executed on remote servers from the computing device 702. Resources 718 can also include services provided over the Internet and/or through a subscriber network, such as a cellular or Wi-Fi network.

Platform 716 abstracts resources and functions to connect computing device 702 with other computing devices. The platform 716 also serves to abstract scaling of resources to provide a corresponding level of scale to encountered demand for the resources 718 implemented via the platform 716. Accordingly, in an interconnected device embodiment, the implementation of functionality described herein is distributable throughout the system 700. For example, the functionality is implementable in part on the computing device 702 and via the platform 716, which abstracts the functionality of the cloud 714.

What is claimed is:

1.-20. (canceled)

21. A method comprising:
receiving, by a processing device, a user prompt to generate digital content, the user prompt including an objective for the digital content;
identifying, by a machine-learning model, a hero section in a template for generating the digital content, the hero section being identified by:
determining that a candidate image in the template is a hero image based on a weighted probability analysis and log-likelihood ratios of multiple image features including at least two of a number of elements above the candidate image, a size of the elements above the candidate image, image dimensions of the candidate image, a vertical positioning of the candidate image, or an aspect ratio of the candidate image; or
determining that a candidate textual element in the template is hero content based on a weighted probability analysis and log-likelihood ratios of multiple text features including at least two of a display level of the candidate textual element, an ordering of the candidate textual element, a size of the candidate textual element, a size of textual elements above the candidate textual element, a level of a container holding the candidate textual element, and a relative size of the candidate textual element; and
generating, by the machine-learning model and based on the user prompt, the digital content with the hero section in the digital content being directed to the objective.

22. The method of claim 21, wherein the machine-learning model identifies the hero image by:
determining, for each candidate image of the template and for each image feature of the multiple image features, a probability that the candidate image is the hero image;
assigning a weight for each image feature of the multiple image features;
determining, for each candidate image and based on a summed weighted log-likelihood ratio for the multiple image features, a combined probability that the candidate image is the hero image; and
in response to the combined probability exceeding a predetermined threshold, classifying the candidate image as the hero image.

23. The method of claim 22, wherein:
the combined probability for each candidate image and for each image feature is determined based on a probability value associated with a range of image feature values, the probability value being determined based on historical data; and
the weight for each image feature is determined based on the historical data, wherein weights for the multiple image features sum to one.

24. The method of claim 22, wherein:
the summed weighted log-likelihood ratio is determined by summing a weighted log-likelihood ratio for each image feature, the weighted log-likelihood ratio being equal to the weight times a difference of a log of the probability and the log of one minus the probability; and
the combined probability is equal to an inverse of one plus an exponential function of negative one times the summed weighted log-likelihood ratio.

25. The method of claim 22, wherein the machine-learning model, in response to identifying the hero image, identifies the hero content by:
classifying each textual element above the hero image as hero content;
in response to the hero image being located in a main section of the template, analyzing each textual element below the hero image based on the multiple text features until another image is encountered in the template; and
in response to the hero image not being located in the main section of the template, analyzing each textual element in a same section as the hero image based on the multiple text features.

26. The method of claim 25, wherein the machine-learning model identifies hero content from among multiple textual elements by:
retrieving each textual element of each section of the template, starting with a first section of the template; and
analyzing each textual element to determine whether the textual element is hero content by:
determining, for each text feature of the multiple text features associated with hero content, a probability that the textual element is hero content;
assigning a weight for each text feature of the multiple text features;
determining, based on a summed weighted log-likelihood ratio for the multiple text features, a combined probability that the textual element is the hero content; and
in response to the combined probability exceeding a predetermined threshold, classifying the textual element as the hero content.

27. The method of claim 26, wherein each textual element in a section of the template is classified as not hero content in response to a single textual element in the section being classified as not hero content.

28. The method of claim 21, wherein the hero image is also determined based on whether the candidate image has sibling images, the sibling images being identified by comparing the vertical positioning, the image dimensions, and the aspect ratio of other images to the candidate image.

29. The method of claim 21, wherein the template is in a Hypertext Markup Language (HTML) format and the digital content is a HTML-based document.

30. The method of claim 21, wherein the template is selected based on the one or more objectives or a type of the digital content.

31. A system comprising:
a memory component; and
a processing device coupled to the memory component, the processing device configured to:
receive a user prompt to generate digital content, the user prompt including an objective for the digital content;
select, by a user or a machine-learning model, a template for the digital content;
identify, by a machine-learning model, a hero section in a template for generating the digital content, the hero section being identified by:
determining that a candidate image in the template is a hero image based on a weighted probability analysis and log-likelihood ratios of multiple image features including at least two of a number of elements above the candidate image, a size of the elements above the candidate image, image dimensions of the candidate image, a vertical positioning of the candidate image, or an aspect ratio of the candidate image; or
determining that a candidate textual element in the template is hero content based on a weighted probability analysis and log-likelihood ratios of multiple text features including at least two of a display level of the candidate textual element, an ordering of the candidate textual element, a size of the candidate textual element, a size of textual elements above the candidate textual element, a level of a container holding the candidate textual element, and a relative size of the candidate textual element; and
generate, by the machine-learning model and based on the user prompt, the digital content with the hero section in the digital content directed to the objective.

32. The system of claim 31, wherein the machine-learning model is configured to identify the hero image by:
determining, for each candidate image of the template and for each image feature of the multiple image features, a probability that the candidate image is the hero image;
assigning a weight for each image feature of the multiple image features;
determining, for each candidate image and based on a summed weighted log-likelihood ratio for the multiple image features, a combined probability that the candidate image is the hero image; and
in response to the combined probability exceeding a predetermined threshold, classifying the candidate image as the hero image.

33. The system of claim 32, wherein:
the combined probability for each candidate image and for each image feature is determined based on a probability value associated with a range of image feature values, the probability value being determined based on historical data;
the weight for each image feature is determined based on the historical data, wherein weights for the multiple image features sum to one;
the summed weighted log-likelihood ratio is determined by summing a weighted log-likelihood ratio for each image feature, the weighted log-likelihood ratio being equal to the weight times a difference of a log of the probability and the log of one minus the probability; and
the combined probability is equal to an inverse of one plus an exponential function of negative one times the summed weighted log-likelihood ratio.

34. The system of claim 32, wherein the machine-learning model, in response to identifying the hero image, is further configured to identify the hero content by:
classifying each textual element above the hero image as hero content;
in response to the hero image being located in a main section of the template, analyzing each textual element below the hero image based on the multiple text features until another image is encountered in the template; and
in response to the hero image not being located in the main section of the template, analyzing each textual element in a same section as the hero image based on the multiple text features.

35. The system of claim 34, wherein the machine-learning model is configured to identify hero content from among the multiple textual elements by:
retrieving each textual element of each section of the template, starting with a first section of the template; and
analyzing each textual element to determine whether the textual element is hero content by:
determining, for each feature of the multiple features associated with hero content, a probability that the textual element is hero content;
assigning a weight for each feature of the multiple features;
determining, based on a summed weighted log-likelihood ratio for the multiple features, a combined probability that the textual element is the hero content; and
in response to the combined probability exceeding a predetermined threshold, classifying the textual element as the hero content.

36. The system of claim 35, wherein the weights for identifying the hero image and the hero content are iteratively updated based on feedback from the machine-learning model evaluating an accuracy of hero section identifications.

37. The system of claim 31, wherein the machine-learning model selects the template based on the objective or a type of digital content to be generated.

38. A non-transitory computer-readable storage medium storing executable instructions, which when executed by a processing device, cause the processing device to perform operations comprising:
receive a user prompt to generate digital content, the user prompt including an objective for the digital content;
identify, by a machine-learning model, a hero section in a template for generating the digital content, the template being selected based on the objective or a type of digital content, the hero section being identified by:
determining that a candidate image in the template is a hero image based on a weighted probability analysis and log-likelihood ratios of multiple images features including at least two of a number of elements above the candidate image, a size of the elements above the candidate image, image dimensions of the candidate image, a vertical positioning of the candidate image, and an aspect ratio of the candidate image; or
determining that a candidate textual element in the template is hero content based on a weighted probability analysis and log-likelihood ratios of multiple text features including at least two of a display level of the candidate textual element, an ordering of the candidate textual element, a size of the candidate textual element, a size of textual elements above the candidate textual element, a level of a container holding the candidate textual element, and a relative size of the candidate textual element; and
generate, by the machine-learning model and based on the user prompt, the digital content with the hero section in the digital content being directed to the objective.

39. The non-transitory computer-readable storage medium of claim 38, wherein the machine-learning model identifies the hero image by:
determining, for each candidate image of the template and for each image feature of the multiple image features, a probability that the candidate image is the hero image;
assigning a weight for each image feature of the multiple image features;
determining, for each candidate image and based on a summed weighted log-likelihood ratio for the multiple image features, a combined probability that the candidate image is the hero image; and
in response to the combined probability exceeding a predetermined threshold, classifying the candidate image as the hero image.

40. The non-transitory computer-readable storage medium of claim 39, wherein the machine-learning model, in response to identifying the hero image, identifies the hero content by:
classifying each textual element above the hero image as hero content;
in response to the hero image being located in a main section of the template, analyzing each textual element below the hero image based on the multiple text features until another image is encountered in the template; and
in response to the hero image not being located in the main section of the template, analyzing each textual element in a same section as the hero image based on the multiple text features.
